(19) United States
(12) Patent Application Publication
(10) Pub. No.: US 2022/0035891 A1
(43) Pub. Date: Feb. 3, 2022

(54) REDUCED RESULT MATRIX

(71) Applicant: QUALCOMM Incorporated, San Diego, CA (US)

(72) Inventors: Eric Wayne MAHURIN, Austin, TX (US); Erich PLONDKE, Austin, TX (US)

(21) Appl. No.: 17/390,257

(22) Filed: Jul. 30, 2021

Related U.S. Application Data
(60) Provisional application No. 63/059,566, filed on Jul. 31, 2020.

(51) Int. Cl. G06F 17/16; G06F 7/525

(52) U.S. Cl. CPC G06F 17/16; G06F 7/525

(57) ABSTRACT

Matrix multiple operations may use a reduced result matrix to increase the speed and accuracy of the operation. In one example, each higher precision row/column is decomposed into multiple component rows/columns of the base type that can be combined as weighted sums to form the original higher precision row/column. In another example, the decomposition may be independent for each input matrix and decompose to any multiple of the base type. In another example, the base type for each input matrix could be different. In another example, after decomposition, a matrix operation is performed (e.g. matrix multiply, convolutional layer, or possibly other matrix operation) on decomposed base type input matrices to yield a result matrix that contains components of the higher precision results. The results may be combined together to obtain higher-precision results.

### CROSS-REFERENCE TO RELATED APPLICATION

The present application for patent claims the benefit of U.S. Provisional Application No. 63/059,566 entitled “REDUCED RESULT MATRIX”, filed Jul. 31, 2020, which is assigned to the Assignee hereof, and is expressly incorporated herein by reference in its entirety.

### FIELD OF DISCLOSURE

This disclosure relates generally to matrix multiplication, and more specifically, but not exclusively, to precision matrix multiplication.

### BACKGROUND

The multiplication of matrices is a well-known operation for computers. It is useful for a wide variety of operations, one of them being the solution of simultaneous equations. In the interest of efficiency, it is highly desirable to perform these operations at increasing speeds. For example, a simulation in the area of research and/or development that may run more quickly will tend to enhance the productivity of the scientist or engineer without incurring additional resources, such as hardware costs.

In solving large matrix multiplications for large or real time problems, scientists and engineers have turned to processors supporting high speed operations, pipelined architectures and/or parallel processing. A series of subroutine libraries have been developed for matrix multiplication, including 8-bit architectures (e.g., Basic Linear Algebra Subprograms (BLAS) subroutine libraries). These subroutine libraries support the high-level function of matrix multiplication, and are available for a variety of processors.

In some applications, the subroutines are written for 8-bit inputs. The subroutines may make calls to a simple matrix algebra subroutine and expect rapid performance from the system on the 8-bit inputs. In designing these subroutines, increased speed is one of the desired design objectives sought. For any given architecture, there are several limiting parameters that affect matrix multiplication speed, such as the number of computations needed to perform the operation, the precision of these operations, and the data type of the input.

For example, a mismatched matrix multiply operation may require as much computational time as a matched matrix multiple operation of full matrix. In other words, a 16×8 bit matrix multiply operation using a standard 8-bit processor architecture may take just as long as a 16×16 matrix multiply operation even though fewer algebra operations are actually being performed.

These problems have been addressed in different ways. Memory bandwidth has been increased by using memories that cycle faster, and by using larger word sizes. Latency has been addressed by using memories with faster access times and by making computers more hierarchical. This involves adding small areas of expensive high speed memory that are local to a processor. Examples of hierarchical memory include cache memories, virtual memory, and large register sets. However, these conventional methods of matrix operation may be made more efficient. Accordingly, there is a need for solutions that overcome the deficiencies of conventional approaches.

### SUMMARY

The following presents a simplified summary relating to one or more aspects and/or examples associated with the apparatus and methods disclosed herein. As such, the following summary should not be considered an extensive overview relating to all contemplated aspects and/or examples, nor does the following summary identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, an apparatus for a matrix operation comprises: a memory configured to store a first result; a processor coupled to the memory, the processor configured to: decompose a data component into a low first component and a high first component; perform a first matrix operation on the low first component to generate the first result; store the first result in the memory; perform a second matrix operation on the high first component to generate a second result; and combine the first result and the second result to generate a final result, wherein the final result is a result of a third matrix operation on the data component.

In another aspect, an apparatus for a matrix operation comprises: means for storing a first result; means for processing coupled to the means for storing, the means for processing configured to: decompose a data component into a low first component and a high first component; perform a first matrix operation on the low first component to generate the first result; store the first result in the means for storing; perform a second matrix operation on the high first component to generate a second result; and combine the first result and the second result to generate a final result, wherein the final result is a result of a third matrix operation on the data component.

In still another aspect, a method for a matrix operation comprises: inputting a data component; decomposing the data component into a low first component and a high first component; performing a first matrix operation on the low first component to generate a first result; storing the first result in the memory; performing a second matrix operation on the high first component to generate a second result; and combining the first result and the second result to generate a final result, wherein the final result is a result of a third matrix operation on the data component.

In still another aspect, a non-transitory computer-readable medium comprising instructions that when executed by a processor cause the processor to perform a method comprises: inputting a data component; decomposing the data component into a low first component and a high first component; performing a first matrix operation on the low first component to generate a first result; storing the first result in the memory; performing a second matrix operation on the high first component to generate a second result; and
combining the first result and the second result to generate a final result, wherein the final result is a result of a third matrix operation on the data component.

Other features and technical advantages associated with the apparatus and methods disclosed herein, will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary matrix operation in accordance with some examples of the disclosure;

FIG. 2 illustrates an exemplary decomposition of a data component in accordance with some examples of the disclosure.

FIGS. 3A and B illustrate exemplary apparatus for performing a matrix operation in accordance with some examples of the disclosure.

FIG. 4 illustrates an exemplary partial method in accordance with some examples of the disclosure.

FIG. 5 illustrates an exemplary mobile device in accordance with some examples of the disclosure.

FIG. 6 illustrates various electronic devices that may be integrated with any of the aforementioned methods, devices, semiconductor devices, integrated circuits, die, interposers, packages, or package-on-packages (PoPs) in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods and apparatus disclosed herein mitigate the shortcomings of the conventional methods and apparatus, as well as other previously unidentified needs. For example, matrix multiple operations may use a reduced result matrix to increase the speed and accuracy of the matrix operation. In one example, each higher precision row/column of a matrix is decomposed into multiple component rows/columns of a base type (e.g., an 8 bit data component) that can be combined as weighted sums to form the original higher precision row/column. In another example, the decomposition may be independent for each input matrix and decompose to any multiple of the base type. In another example, the base type for each input matrix could be different. In another example, after decomposition, a matrix operation is performed (e.g. matrix multiply, convolutional layer, or possibly other matrix operation) on decomposed base type input matrices to yield a result matrix that contains components of the higher precision results. The results may be combined together to obtain higher-precision results.

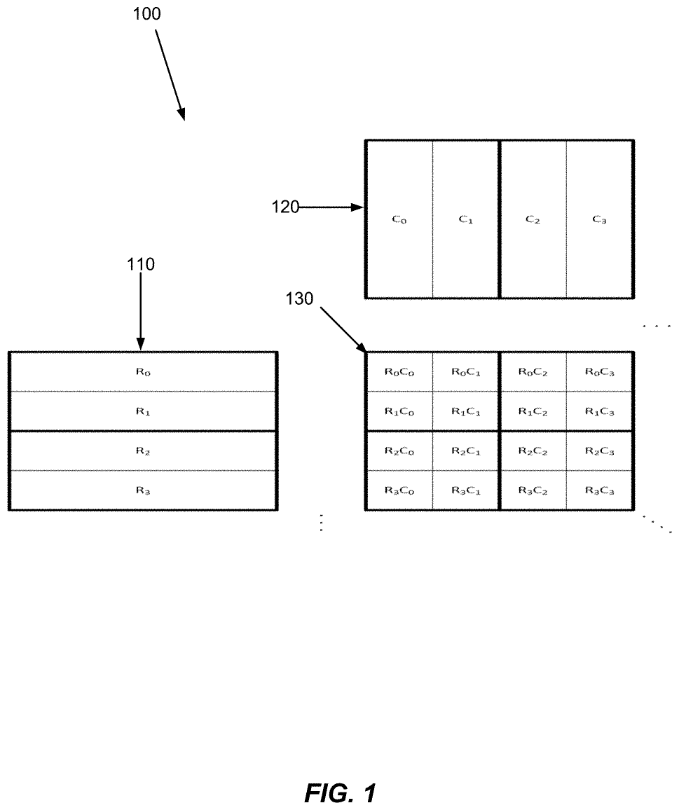

FIG. 1 illustrates an exemplary matrix operation in accordance with some examples of the disclosure. As shown in FIG. 1, a matrix operation 100 may be performed on a data component that comprises a plurality of matrix rows 110 and a plurality of components include a plurality of rows 110 and a plurality of columns 120. A matrix operation 100, such as a matrix multiply operation, on the data component generates a final result 130. As shown, the matrix operation is a multiply operation that results in a dot product matrix 130 of the plurality of rows 110 and the plurality of columns 120.

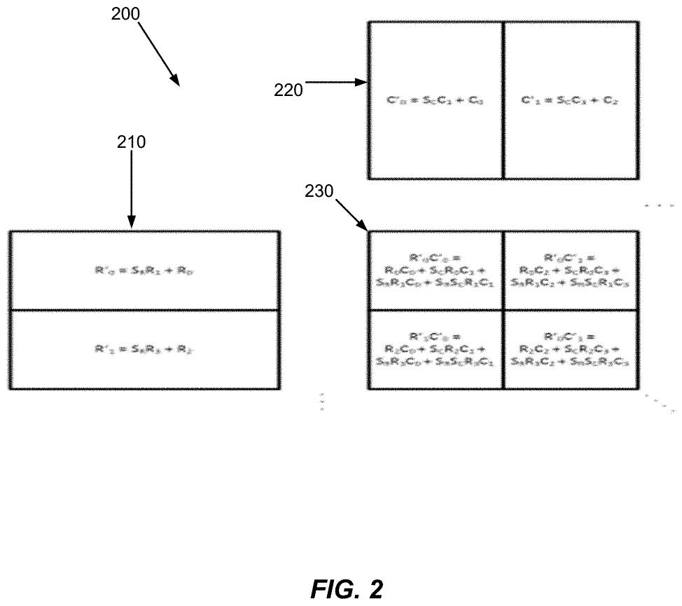

FIG. 2 illustrates an exemplary decomposition of a data component 200 in accordance with some examples of the disclosure. As shown in FIG. 2, the precision for each operand may be doubled by treating the data component as higher-precision inputs by decomposing each higher precision row/column (e.g., R′₀=S_{R}R₂+R1) into multiple component rows 210 and multiple component columns 220 of the base type that may be combined (e.g., by a weighted sum) to generate a final result 230 for the original higher precision row/column. While this amplifies the number of rows and columns of the base type relative to the higher precision input matrices and thus the number of matrix operations performed. Those skilled in the art will appreciate that component rows/columns for a higher precision row/column do not need to be adjacent. The decomposition can be independent for each input matrix and decompose to any multiple of the base type. The base type for each input matrix could be different (e.g. 16×8 instead of 8×8 or 16×16). Perform the operations for matrix multiply, convolutional layer, or possibly other matrix operation on decomposed base type input matrices 210 and 220 to yield a result matrix 230 (containing components of the higher precision results). This may include multiple matrix operations working in this decomposed domain (e.g., 8 bit) that may accumulated together to generate the final result.

When the results are complete or ready to be converted to input for the next operation, the component results may be combined together to obtain higher-precision results. In one example, each combination may be implemented serially (e.g. multi-pump) to reduce hardware cost. This supports higher-precision, inexpensive multi-pumped operations (e.g., input add, shifting, multiplying, and output add) in the conversion and multi-pumped streaming of higher-precision results. In addition, decomposition, matrix operation, and results generation may be performed in parallel (for each group of result elements) regardless of high-precision element handling.

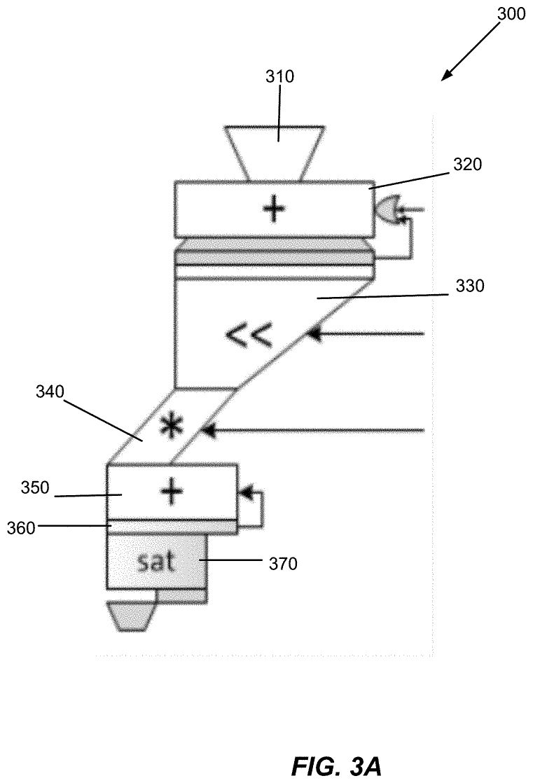

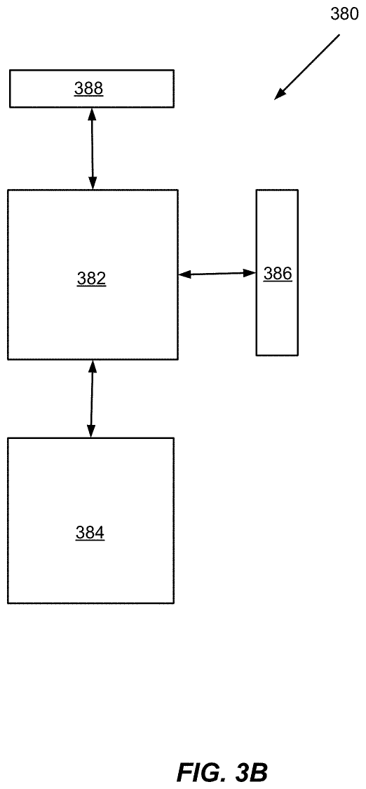

FIGS. 3A and B illustrate exemplary apparatus for performing a matrix operation in accordance with some examples of the disclosure. As shown in FIG. 3A, an apparatus 300 for a matrix operation, such as the fundamental initial convert component, may use an 8 bit architecture for 16 bit handling that can handle 16×8 and 16×16, for example. In a 16×8 operation, high/low weight bytes may be used to cut the spatial component in half and the array becomes effectively 32 spatial by 32 depth. In a 16×16 operation, high/low weight bytes may be used to cut the output (depth) channels in half and the array becomes effectively 32 spatial by 16 depth.

As shown in FIG. 3A, the apparatus 300 for a matrix operation may include an input stage 310 that inputs a data component, a first accumulator 320 for combining the results for matrix operations with another data source 320, a decomposition stage 330 that decomposes the input data component into one or more low components and one or more high components, a matrix operation stage 340 that performs a matrix (or a convolution layer) operation on the decomposed low and high components, a second accumulator 350 for combining the results of the matrix operation stage 340, and a memory 360 (e.g., one or more registers for storing/holding 8 bit base type results, and a saturation counter 370 for managing the memory 360.

In one example of matrix multiply operation, each accumulator 320 and 360 may hold a specific 8×8 high/low component dot-product. This may allow the use of a booth encoding like technique for 16 bit signed weights into 8 bit signed high and 8 bit signed low with no change to conventional media access controller (MAC) instructions needed. The operation resembles the dilate and/or doing one vertical tap at a time (treating element bytes as vertical) work for convolution layers and computing. However, new convert instructions may be used to connect each convert module to at least two adjacent spatial and two adjacent output channels. This may allow the high/low bytes for each 16 bit element to be adjacent. Conventional convert modules connect only spatially with a stride of 8. This will generally impact the order of converts (CVT) and the interface to the MX write buffer but may still allow an 8:1 ratio between MAC & CVT tiles. Then, each 8*8 component is serially added up in the accumulators along with the bias or weights. When using the second accumulator 350 and decomposed 8 bit intermediate component, for example, it takes 2 cycles for 16×8 and 4 cycles for 16×16. To eliminate a specific add input for bias, the second accumulator 350 should be added with the part of the bias it overlaps. As the partial accumulator sum is shifted right, more bias bits (8) can be put in the vacant bits. For signed accumulators, invert the sign bit and −1 there into the bias and also invert the incoming accumulator sign bit. Then, serially multiply from this under the serial addition above. In these examples, 16×8 gets a 20*11 multiply in 2 cycles and 16×16 gets a 20*22 multiply in 4 cycles. The intermediate product will be shifted to maintain alignment. The output side may be saturate to 16 bit and then serially stream out the 2 bytes. This example may incur extra latency to the memory of: 16×8: 1+1=2 cycles; 16×16: 3+3=6 cycles without any additional latency on the accumulator interlock. This may be extended to 32×16 as well that will have eight 8×8 components. This allows all bigger operations to be time-interleaved from the basic operations needed for 8 bit only.

As shown in FIG. 3B, an apparatus 380 for a matrix operation may include a processor 382 coupled between a first memory 384 (e.g., main system memory or cache), a second memory 386 (e.g., a register comprising at least one 8 bit value), and a third memory 388 (e.g., a register comprising at least one 8 bit value). The processor 382 may input a data component from the first memory 384, decompose the data component into a low first component and a high first component, perform a matrix operation on the low first component to generate a first result and store the first result in the second memory 386, perform a matrix operation on the high first component to generate the second result and store the second result in the third memory 388, and combine the first result and the second result to generate a final result wherein the final result is a result of the matrix operation on the data component. It should be understood that the first matrix operation may be the same as the second matrix operation; the first matrix operation and the second matrix operation may be performed simultaneously; the low first component and the high first component may be serially combined in one of the memories; the data component is may be X by a Y matrix with the X and the Y being integer multiples of 8; and the processor may be incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

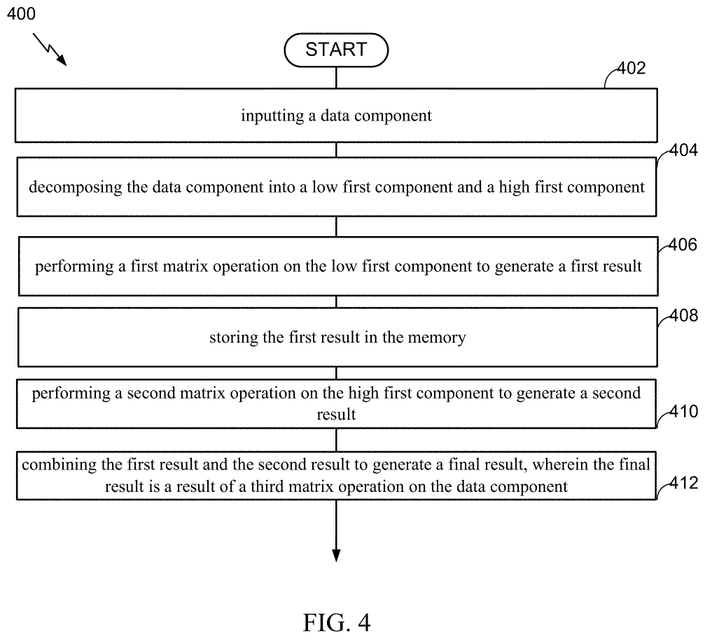

FIG. 4 illustrates an exemplary partial method for a matrix operation in accordance with some examples of the disclosure. As shown in FIG. 4, the partial method 400 may begin in block 402 with inputting a data component. The partial method 400 may continue in block 404 with decomposing the data component into a low first component and a high first component. The partial method 400 may continue in block 406 with performing a first matrix operation on the low first component to generate a first result. The partial method 400 may continue in block 408 with storing the first result in the memory. The partial method 400 may continue in block 410 with performing a second matrix operation on the high first component to generate a second result. The partial method 400 may conclude in block 412 with combining the first result and the second result to generate a final result, wherein the final result is a result of a third matrix operation on the data component.

Alternatively, the partial method 400 may include wherein the first matrix operation is the same as the second matrix operation; the memory is a register comprising at least one 8 bit value; the first matrix operation and the second matrix operation are performed simultaneously; the low first component and the high first component are serially combined in the memory; the data component is an X by a Y matrix with the X and the Y being integer multiples of 8; and performing the method by a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

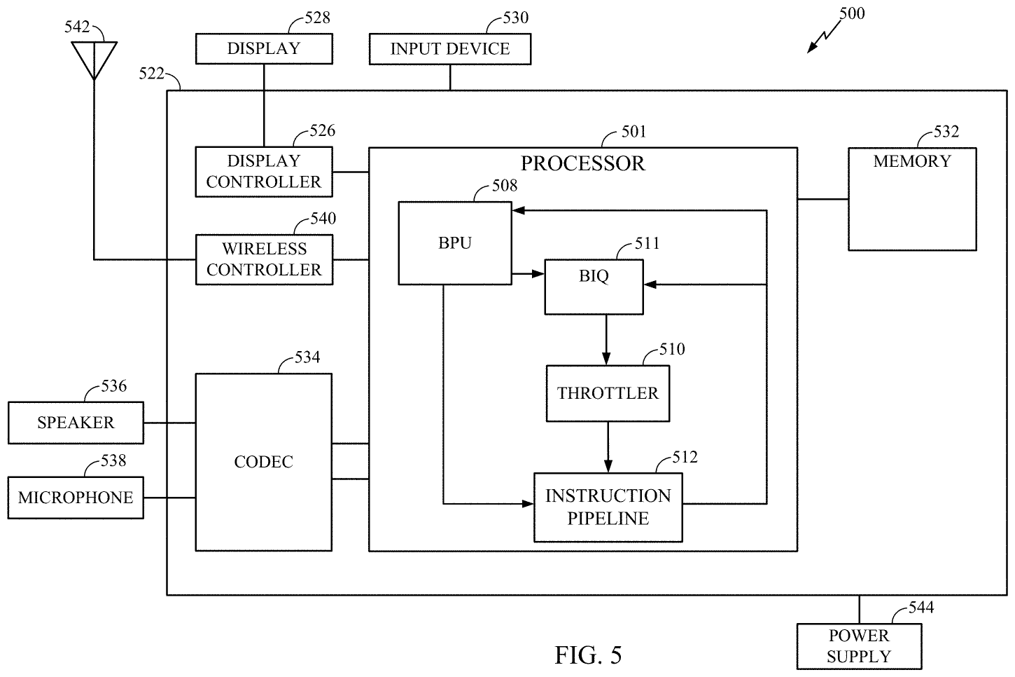

FIG. 5 illustrates an exemplary mobile device in accordance with some examples of the disclosure. Referring now to FIG. 5, a block diagram of a mobile device that is configured according to exemplary aspects is depicted and generally designated 500. In some aspects, mobile device 500 may be configured as a wireless communication device. As shown, mobile device 500 includes processor 501, which may be configured to implement the methods described herein in some aspects. An exemplary processor 501 is shown comprising an instruction pipeline 512, a buffer processing unit (BPU) 508, a branch instruction queue (BIQ) 511, and a throttler 510. Other well-known details to those of skill in the art (e.g., counters, entries, confidence fields, weighted sum, comparator, etc.) of these blocks have been omitted from this view of processor 501 for the sake of clarity.

Processor 501 may be communicatively coupled to memory 532 over a link, which may be a die-to-die link, a chip-to-chip link, or other types of linking mechanisms. Mobile device 500 also include display 528 and display controller 526, with display controller 526 coupled to processor 501 and to display 528.

In some aspects, FIG. 5 may include coder/decoder (CODEC) 534 (e.g., an audio and/or voice CODEC) coupled to processor 501; speaker 536 and microphone 538 coupled to CODEC 534; and wireless controller 540 (which may include a modem) coupled to wireless antenna 542 and to processor 501.

In one exemplary aspect, where one or more of the above-mentioned blocks are present, processor 501, display controller 526, memory 532, CODEC 534, and wireless controller 540 may be included in a system-in-package or system-on-chip device 522. Input device 530 (e.g., physical or virtual keyboard), power supply 544 (e.g., battery), display 528, input device 530, speaker 536, microphone 538, wireless antenna 542, and power supply 544 may be external to system-on-chip device 522 and may be coupled to a component of system-on-chip device 522, such as an interface or a controller.

It should be noted that although FIG. 5 depicts a mobile device implementation, processor 501 and memory 532 may also be integrated into other implementations such as a set top box, a music player, a video player, an entertainment unit, a navigation device, a personal digital assistant (PDA), a fixed location data unit, a computer, a laptop, a tablet, a communications device, a mobile phone, or other similar devices.

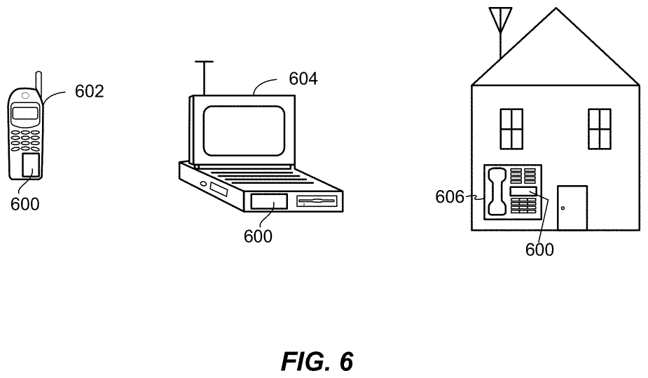

FIG. 6 illustrates various electronic devices that may be integrated with any of the aforementioned integrated device, semiconductor device, integrated circuit, die, interposer, package or package-on-package (PoP) in accordance with some examples of the disclosure. For example, a mobile phone device 602, a laptop computer device 604, and a fixed location terminal device 606 may include an integrated device 600 as described herein. The integrated device 600 may be, for example, any of the integrated circuits, dies, integrated devices, integrated device packages, integrated circuit devices, device packages, integrated circuit (IC) packages, package-on-package devices described herein. The devices 602, 604, 606 illustrated in FIG. 6 are merely exemplary. Other electronic devices may also feature the integrated device 600 including, but not limited to, a group of devices (e.g., electronic devices) that includes mobile devices, handheld personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

It will be appreciated that various aspects disclosed herein can be described as functional equivalents to the structures, materials and/or devices described and/or recognized by those skilled in the art. It should furthermore be noted that methods, and apparatus disclosed in the description or in the claims may be implemented by a device comprising means for performing the respective actions of this method.

For example, in one aspect, an apparatus for a matrix operation comprises: means for storing (e.g., a memory, a register, a cache, or similar) a first result; and means for processing (e.g., a processor or similar) coupled to the means for storing, the means for processing configured to: decompose a data component into a low first component and a high first component; perform a first matrix operation on the low first component to generate the first result; store the first result in the means for storing; perform a second matrix operation on the high first component to generate a second result; and combine the first result and the second result to generate a final result, wherein the final result is a result of a third matrix operation on the data component. It will be appreciated that the aforementioned aspects are merely provided as examples and the various aspects claimed are not limited to the specific references and/or illustrations cited as examples.

One or more of the components, processes, features, and/or functions illustrated in FIGS. 1-6 may be rearranged and/or combined into a single component, process, feature or function or incorporated in several components, processes, or functions. Additional elements, components, processes, and/or functions may also be added without departing from the disclosure. It should also be noted that FIGS. 1-6 and its corresponding description in the present disclosure is not limited to dies and/or ICs. In some implementations, FIGS. 1-6 and its corresponding description may be used to manufacture, create, provide, and/or produce integrated devices. In some implementations, a device may include a die, an integrated device, a die package, an integrated circuit (IC), a device package, an integrated circuit (IC) package, a wafer, a semiconductor device, a package on package (PoP) device, and/or an interposer. An active side of a device, such as a die, is the part of the device that contains the active components of the device (e.g. transistors, resistors, capacitors, inductors etc.), which perform the operation or function of the device. The backside of a device is the side of the device opposite the active side.

As used herein, the terms “user equipment” (or “UE”), “user device,” “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can receive wireless communication and/or navigation signals. These terms include, but are not limited to, a music player, a video player, an entertainment unit, a navigation device, a communications device, a smartphone, a personal digital assistant, a fixed location terminal, a tablet computer, a computer, a wearable device, a laptop computer, a server, an automotive device in an automotive vehicle, and/or other types of portable electronic devices typically carried by a person and/or having communication capabilities (e.g., wireless, cellular, infrared, short-range radio, etc.). These terms are also intended to include devices which communicate with another device that can receive wireless communication and/or navigation signals such as by short-range wireless, infrared, wireline connection, or other connection, regardless of whether satellite signal reception, assistance data reception, and/or position-related processing occurs at the device or at the other device. In addition, these terms are intended to include all devices, including wireless and wireline communication devices, that are able to communicate with a core network via a radio access network (RAN), and through the core network the UEs can be connected with external networks such as the Internet and with other UEs. Of course, other mechanisms of connecting to the core network and/or the Internet are also possible for the UEs, such as over a wired access network, a wireless local area network (WLAN) (e.g., based on IEEE 802.11, etc.) and so on. UEs can be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to an uplink/reverse or downlink/forward traffic channel.

The wireless communication between electronic devices can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE), Bluetooth (BT), Bluetooth Low Energy (BLE), IEEE 802.11 (WiFi), and IEEE 802.15.4 (Zigbee/Thread) or other protocols that may be used in a wireless communications network or a data communications network. Bluetooth Low Energy (also known as Bluetooth LE, BLE, and Bluetooth Smart) is a wireless personal area network technology designed and marketed by the Bluetooth Special Interest Group intended to provide considerably reduced power consumption and cost while maintaining a similar communication range. BLE was merged into the main Bluetooth standard in 2010 with the adoption of the Bluetooth Core Specification Version 4.0 and updated in Bluetooth 5 (both expressly incorporated herein in their entirety).

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations). Additionally, these sequence of actions described herein can be considered to be incorporated entirely within any form of computer-readable storage medium (transitory and non-transitory) having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

In the detailed description above, note that different features are grouped together in various examples. This manner of disclosure should not be understood as an intention that the example clauses have more features than are explicitly mentioned in each clause. Rather, the various aspects of the disclosure may include fewer than all the features of an individual, example clause disclosed. Therefore, the following clauses should be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses may also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g. contradictory aspects, such as defining an element as both an insulator and a conductor). Furthermore, it is also intended that aspects of a clause may be included in any other independent clause, even if the clause is not directly dependent on the independent clause.

Clause 1. An apparatus for a matrix operation, the apparatus comprising: a memory configured to store a first result; a processor coupled to the memory, the processor configured to: decompose a data component into a low first component and a high first component; perform a first matrix operation on the low first component to generate the first result; store the first result in the memory; perform a second matrix operation on the high first component to generate a second result; and combine the first result and the second result to generate a final result, wherein the final result is a result of a third matrix operation on the data component.

Clause 2. The apparatus of clause 1, wherein the first matrix operation is the same as the second matrix operation.

Clause 3. The apparatus of any of clauses 1 to 2, wherein the memory is a register comprising at least one 8 bit value.

Clause 4. The apparatus of any of clauses 1 to 3, wherein the first matrix operation and the second matrix operation are performed simultaneously.

Clause 5. The apparatus of any of clauses 1 to 4, wherein the low first component and the high first component are serially combined in the memory.

Clause 6. The apparatus of any of clauses 1 to 5, wherein the data component is an X by a Y matrix with the X and the Y being integer multiples of 8.

Clause 7. The apparatus of any of clauses 1 to 6, wherein the processor is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

Clause 8. An apparatus for a matrix operation, the apparatus comprising: means for storing a first result; means for processing coupled to the means for storing, the means for processing configured to: decompose a data component into a low first component and a high first component; perform a first matrix operation on the low first component to generate the first result; store the first result in the means for storing; perform a second matrix operation on the high first component to generate a second result; and combine the first result and the second result to generate a final result, wherein the final result is a result of a third matrix operation on the data component.

Clause 9. The apparatus of clause 8, wherein the first matrix operation is the same as the second matrix operation.

Clause 10. The apparatus of any of clauses 8 to 9, wherein the means for storing is a register comprising at least one 8 bit value.

Clause 11. The apparatus of any of clauses 8 to 10, wherein the first matrix operation and the second matrix operation are performed simultaneously.

Clause 12. The apparatus of any of clauses 8 to 11, wherein the low first component and the high first component are serially combined in the means for storing.

Clause 13. The apparatus of any of clauses 8 to 12, wherein the data component is an X by a Y matrix with the X and the Y being integer multiples of 8.

Clause 14. The apparatus of any of clauses 8 to 13, wherein the means for processing is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

Clause 15. A method for a matrix operation, the method comprising: inputting a data component; decomposing the data component into a low first component and a high first component; performing a first matrix operation on the low first component to generate a first result; storing the first result in the memory; performing a second matrix operation on the high first component to generate a second result; and combining the first result and the second result to generate a final result, wherein the final result is a result of a third matrix operation on the data component.

Clause 16. The method of clause 15, wherein the first matrix operation is the same as the second matrix operation.

Clause 17. The method of any of clauses 15 to 16, wherein the memory is a register comprising at least one 8 bit value.

Clause 18. The method of any of clauses 15 to 17, wherein the first matrix operation and the second matrix operation are performed simultaneously.

Clause 19. The method of any of clauses 15 to 18, wherein the low first component and the high first component are serially combined in the memory.

Clause 20. The method of any of clauses 15 to 19, wherein the data component is an X by a Y matrix with the X and the Y being integer multiples of 8.

Clause 21. The method of any of clauses 15 to 20, wherein the method is performed by a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

Clause 22. A non-transitory computer-readable medium comprising instructions that when executed by a processor cause the processor to perform a method comprising: inputting a data component; decomposing the data component into a low first component and a high first component; performing a first matrix operation on the low first component to generate a first result; storing the first result in the memory; performing a second matrix operation on the high first component to generate a second result; and combining the first result and the second result to generate a final result, wherein the final result is a result of a third matrix operation on the data component.

Clause 23. The non-transitory computer-readable medium of clause 22, wherein the first matrix operation is the same as the second matrix operation.

Clause 24. The non-transitory computer-readable medium of any of clauses 22 to 23, wherein the memory is a register comprising at least one 8 bit value.

Clause 25. The non-transitory computer-readable medium of any of clauses 22 to 24, wherein the first matrix operation and the second matrix operation are performed simultaneously.

Clause 26. The non-transitory computer-readable medium of any of clauses 22 to 25, wherein the low first component and the high first component are serially combined in the memory.

Clause 27. The non-transitory computer-readable medium of any of clauses 22 to 26, wherein the data component is an X by a Y matrix with the X and the Y being integer multiples of 8.

Clause 28. The non-transitory computer-readable medium of any of clauses 22 to 27, wherein the non-transitory computer-readable medium is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

What is claimed is:

1. An apparatus comprising:
a memory configured to store a first result;
a processor coupled to the memory, the processor configured to:
decompose a data component into a low first component and a high first component;
perform a first matrix operation on the low first component to generate the first result;
store the first result in the memory;
perform a second matrix operation on the high first component to generate a second result; and
combine the first result and the second result to generate a final result, wherein the final result is a result of a third matrix operation on the data component.

2. The apparatus of claim 1, wherein the first matrix operation is the same as the second matrix operation.

3. The apparatus of claim 1, wherein the memory is a register comprising at least one 8 bit value.

4. The apparatus of claim 1, wherein the first matrix operation and the second matrix operation are performed simultaneously.

5. The apparatus of claim 1, wherein the low first component and the high first component are serially combined in the memory.

6. The apparatus of claim 1, wherein the data component is an X by a Y matrix with the X and the Y being integer multiples of 8.

7. The apparatus of claim 1, wherein the processor is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

8. An apparatus for a matrix operation, the apparatus comprising:
means for storing a first result;
means for processing coupled to the means for storing, the means for processing configured to:
decompose a data component into a low first component and a high first component;
perform a first matrix operation on the low first component to generate the first result;
store the first result in the means for storing;
perform a second matrix operation on the high first component to generate a second result; and
combine the first result and the second result to generate a final result, wherein the final result is a result of a third matrix operation on the data component.

9. The apparatus of claim 8, wherein the first matrix operation is the same as the second matrix operation.

10. The apparatus of claim 8, wherein the means for storing is a register comprising at least one 8 bit value.

11. The apparatus of claim 8, wherein the first matrix operation and the second matrix operation are performed simultaneously.

12. The apparatus of claim 8, wherein the low first component and the high first component are serially combined in the means for storing.

13. The apparatus of claim 8, wherein the data component is an X by a Y matrix with the X and the Y being integer multiples of 8.

14. The apparatus of claim 8, wherein the means for processing is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

15. A method for a matrix operation, the method comprising:
inputting a data component;
decomposing the data component into a low first component and a high first component;
performing a first matrix operation on the low first component to generate a first result;
storing the first result in a memory;
performing a second matrix operation on the high first component to generate a second result; and
combining the first result and the second result to generate a final result, wherein the final result is a result of a third matrix operation on the data component.

16. The method of claim 15, wherein the first matrix operation is the same as the second matrix operation.

17. The method of claim 15, wherein the memory is a register comprising at least one 8 bit value.

18. The method of claim 15, wherein the first matrix operation and the second matrix operation are performed simultaneously.

19. The method of claim 15, wherein the low first component and the high first component are serially combined in the memory.

20. The method of claim 15, wherein the data component is an X by a Y matrix with the X and the Y being integer multiples of 8.

21. The method of claim 15, wherein the method is performed by a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.

22. A non-transitory computer-readable medium comprising instructions that when executed by a processor cause the processor to perform a method comprising:
inputting a data component;
decomposing the data component into a low first component and a high first component;
performing a first matrix operation on the low first component to generate a first result;
storing the first result in a memory;
performing a second matrix operation on the high first component to generate a second result; and
combining the first result and the second result to generate a final result, wherein the final result is a result of a third matrix operation on the data component.

23. The non-transitory computer-readable medium of claim 22, wherein the first matrix operation is the same as the second matrix operation.

24. The non-transitory computer-readable medium of claim 22, wherein the memory is a register comprising at least one 8 bit value.

25. The non-transitory computer-readable medium of claim 22, wherein the first matrix operation and the second matrix operation are performed simultaneously.

26. The non-transitory computer-readable medium of claim 22, wherein the low first component and the high first component are serially combined in the memory.

27. The non-transitory computer-readable medium of claim 22, wherein the data component is an X by a Y matrix with the X and the Y being integer multiples of 8.

28. The non-transitory computer-readable medium of claim 22, wherein the non-transitory computer-readable medium is incorporated into a device selected from the group consisting of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, and a device in an automotive vehicle.
